(19) United States
(12) Patent Application Publication
(10) Pub. No.: US 2010/0279245 A1
(43) Pub. Date: Nov. 4, 2010

(54) Removable Orthodontic Appliance and Method of Forming the Same

(76) Inventor: Carlos F. Navarro, Dallas, TX (US)

Correspondence Address: BAKER BOTTS L.L.P., 2001 ROSS AVENUE, SUITE 600, DALLAS, TX, 75201-2980, US

(21) Appl. No.: 12/772,704

(22) Filed: May 3, 2010

Related U.S. Application Data
(60) Provisional application No. 61/175,258, filed on May 4, 2009.
(60) Provisional application No. 61/176,732, filed on May 8, 2009.

(51) Int. Cl. A61C 7/08; B21F 43/00; A61C 7/28

(52) U.S. Cl. 433/6; 29/896.11; 433/10

(57) ABSTRACT

According to one embodiment, a method of forming an orthodontic appliance includes forming an arch configured to custom fit a plurality of teeth. The method may further include coupling a plurality of wire receptors to at least two of: a first surface of the arch corresponding to the lingual surfaces of the plurality of teeth; a second surface of the arch corresponding to the labial surfaces of the plurality of teeth; and a third surface of the arch corresponding to the occusal surfaces of the plurality of teeth. Selected portions of the composite arch may be separated. A first pair of the plurality of wire receptors may be coupled together using a first orthodontic wire. A second pair of the plurality of wire receptors may be coupled together using a second orthodontic wire.

### RELATED APPLICATIONS

This application claims the benefit under 35 U.S.C. §119(e) of U.S. Provisional Application Ser. Nos. 61/175,258 and 61/176,732 filed May 4, 2009 and May 8, 2009, respectively.

### TECHNICAL FIELD

This disclosure relates in general to dental appliances, and more particularly to a removable orthodontic appliance and method of forming the same.

### BACKGROUND

Arch wires are frequently used in orthodontic systems to facilitate the application of correctional forces to teeth. Each force applied by the arch wire may push a tooth in a particular direction and a resulting stress is created within the periodontal ligament. The modification of the periodontal blood supply determines a biological response which leads to bone remodeling, where bone is created on one side by osteoblast cells and resorbed on the other side by osteoclasts.

### OVERVIEW

According to one embodiment, a method of forming an orthodontic appliance includes forming an arch configured to custom fit a plurality of teeth. The method may further include coupling a plurality of wire receptors to at least two of a first surface of the arch corresponding to the lingual surfaces of the plurality of teeth; a second surface of the arch corresponding to the labial surfaces of the plurality of teeth; and a third surface of the arch corresponding to the occusal surfaces of the plurality of teeth. Selected portions of the composite arch may be separated. A first pair of the plurality of wire receptors may be coupled together using a first orthodontic wire. A second pair of the plurality of wire receptors may be coupled together using a second orthodontic wire.

Particular embodiments may provide one or more technical advantages. According to one embodiment, an orthodontic appliance is capable of applying correctional forces to teeth. Various embodiments may provide improved flexibility in orthodontic treatment options. In certain embodiments, a variety of moments that may be applied to a tooth using wire receptors placed proximate the most coronal part. For example, mesio-distal direction (tip) and/or labio-lingual direction (torque) can be applied to the crown of the tooth in a single moment. In certain instances the line of the force may pass far away from the center of resistance, thereby enabling a moment in multiple directions and rotation in any direction. In particular embodiments, an orthodontic appliance may be readily removed and then later reapplied as desired to facilitate day-to-day activities, such as, for example, oral hygiene procedures, eating, etc. Various embodiments may facilitate intra-oral and/or extra-oral adjustments of an arch wire of an orthodontic appliance. Particular orthodontic appliances may use multiple wires to facilitate the application of particular moments of force to teeth. For example, some embodiments using multiple wires may apply any number of moments to a tooth including, for example, labia-lingual torque, a vertical force moment, and locally optimized rotational control.

Certain embodiments may provide all, some, or none of these advantages. Certain embodiments may provide one or more other advantages, one or more of which may be apparent to those skilled in the art from the figures, descriptions, and claims included herein.

### BRIEF DESCRIPTION OF THE DRAWINGS

For a more complete understanding of the present disclosure and its advantages, reference is now made to the following description, taken in conjunction with the accompanying drawings, in which:

FIGS. 1A, 1B, and 1C illustrate a removable orthodontic appliance mounted to a plaster model according to one embodiment;

FIG. 1D illustrates a composite arch that may be used in the formation of a removable orthodontic appliance according to one embodiment;

FIG. 2 illustrates multiple perspective views a custom-made cap mounted to a bicuspid according to one embodiment;

FIGS. 3A, 3B, and 3C illustrate side views of a cap, mounted to a maxillary central incisor, with example wire receptors oriented according to various embodiments;

FIGS. 4A and 4B illustrate perspective views of a cap, mounted to a maxillary central incisor, with integrally formed wire receptors according to one embodiment;

FIGS. 5A and 5B illustrate an anchor element according to one embodiment;

FIGS. 6A through 6C illustrate exploded views of removable orthodontic appliances seated within a delivery tray according to various embodiments;

FIG. 7 illustrates is an occlusal perspective of a variety of moments that may be applied to a tooth according to one embodiment;

FIG. 8 illustrates a force being applied in the coronal part; and

FIG. 9 is a flowchart illustrating an example method of forming an orthodontic appliance according to one embodiment.

### DETAILED DESCRIPTION

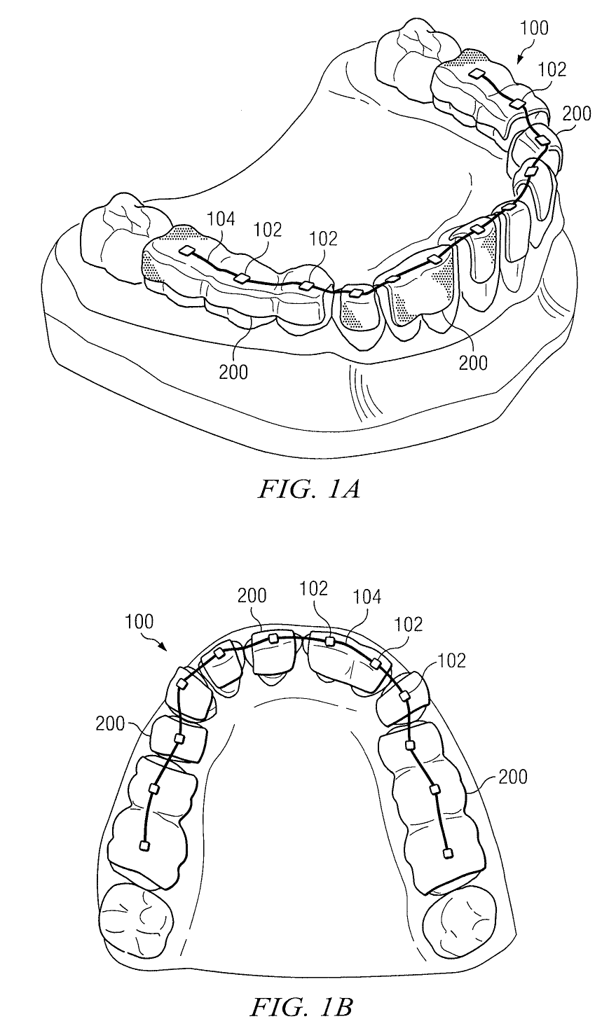

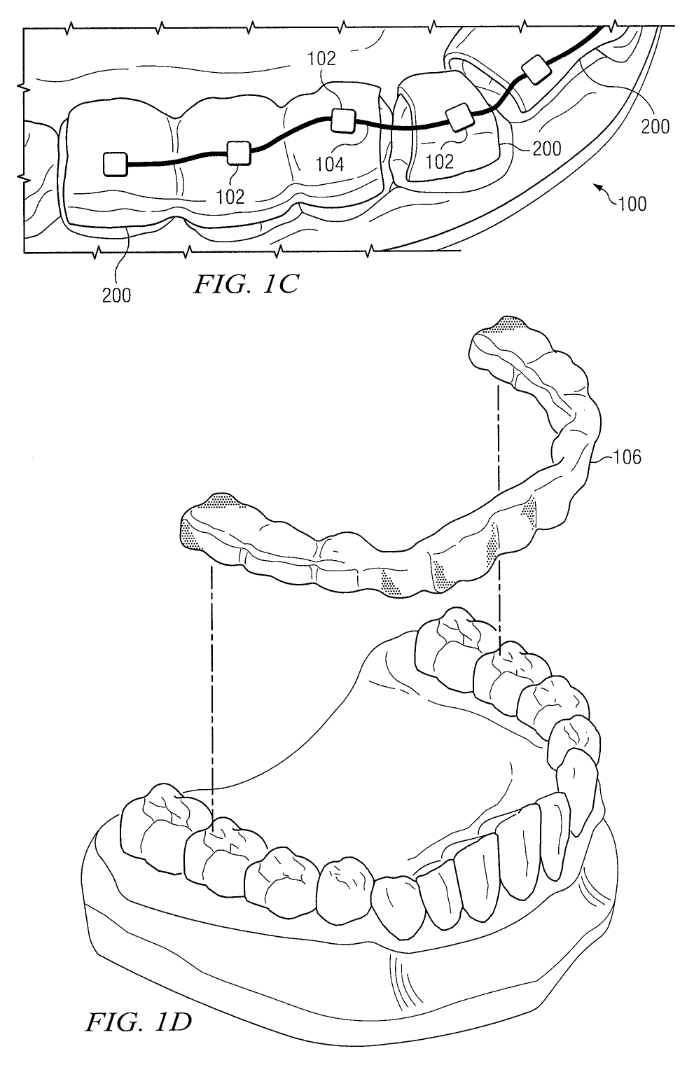

FIGS. 1A, 1B, and 1C illustrate a lateral view, an upper view, and a zoomed view, respectively, of removable orthodontic appliance 100 mounted to a plaster model according to one embodiment. Embodiments of appliance 100 may be used, for example, to apply forces that correct or improve the location, bite, or alignment of a user's teeth. For example, appliance 100 may correct one or more of crowding, misalignment, etc. As described further below, the appliance 100 generally includes a system of caps or copings (e.g., element 200 of FIG. 2) and wire receptors 102 interconnected by orthodontic wire 104. Caps 200 are configured to mount to the occlusal surface of one or more respective teeth. The term “occlusal surface” as used herein generally refers to a tooth surface that is substantially parallel to the occlusal plane. For example, the incisal surface of incisor teeth may also be considered occlusal surfaces for purposes of this disclosure. In addition, the occlusal surface of a molar includes the chewing surface that is proximate a central vertical axis of the molar. In certain embodiments, portions of the appliance 100 may be formed from an arch 106, as shown in FIG. 1D.

FIG. 1D illustrates a composite arch 106 that may be used in the formation of appliance 100. In certain embodiments, arch 106 may be formed from a mold of teeth or directly from the teeth, thereby providing a custom fit. Any suitable material may be used to form arch 106 including, for example, plastics, acrylics and/or composites. In certain embodiments, arch 106 may be separated into selected portions depending, for example, on the desired orthodontic treatment. For example, arch 106 may be separated into two to twelve caps 200, each of which may be configured to mount to one or more respective teeth; however, any suitable number of caps 200 may be used. Each cap 200 may be coupled to one or more respective wire receptors 102.

Wire receptors 102 generally refer to any suitable device capable of coupling to orthodontic wire 104. In certain embodiments, for example, wire receptors 102 may be open-faced, fully or partially enclosed, and/or self-ligating. Examples of self-ligating brackets are disclosed in U.S. Pat. No. 7,186,114 filed Mar. 30, 2004, which is hereby incorporated by reference. Wire receptors 102 may be formed from any suitable material including, for example, ceramic, cobalt, chromium, composite, gold, plastic, nickel, tungsten, stainless steel, titanium, magnesium, or any suitable combination of the preceding. In certain embodiments, appliance 100 is applied to the mouth of a user such that one or more wire receptors 102 may be disposed opposite the occlusal surface of a respective tooth and proximate a central vertical axis of the tooth; however, in some embodiments, wire receptors 102 may be disposed opposite any suitable surface depending on the desired treatment.

As illustrated in FIGS. 1A-1C, wire receptors 102 may be coupled together by orthodontic wire 104. In certain embodiments, one or more wire receptors 102 may be adjustably coupled to orthodontic 104 such that wire 104 may be capable of moving or sliding relative to the coupled wire receptor(s) 102. In particular embodiments, orthodontic wire 104 may be square, round, rectangular, or braided. Orthodontic wire 104 may be formed from any suitable material including, for example, nickel titanium (NiTi), stainless steel, beta titanium (e.g., titanium-molybdenum or TMA), and/or other suitable material.

FIG. 2 illustrates multiple perspective views of a custom-made cap 200 mounted to a bicuspid according to one embodiment. In this example, cap 200 covers at least a portion of the occlusal surface of the bicuspid. Cap 200 may be formed by separating a portion of arch 106. For example, arch 106 may be cut, cleaved, milled, broken, etc. to form multiple caps 200, each of which may be configured to mount to one or more respective teeth. In some embodiments, portions of the composite arch may be selectively removed, thereby creating gaps between caps 200.

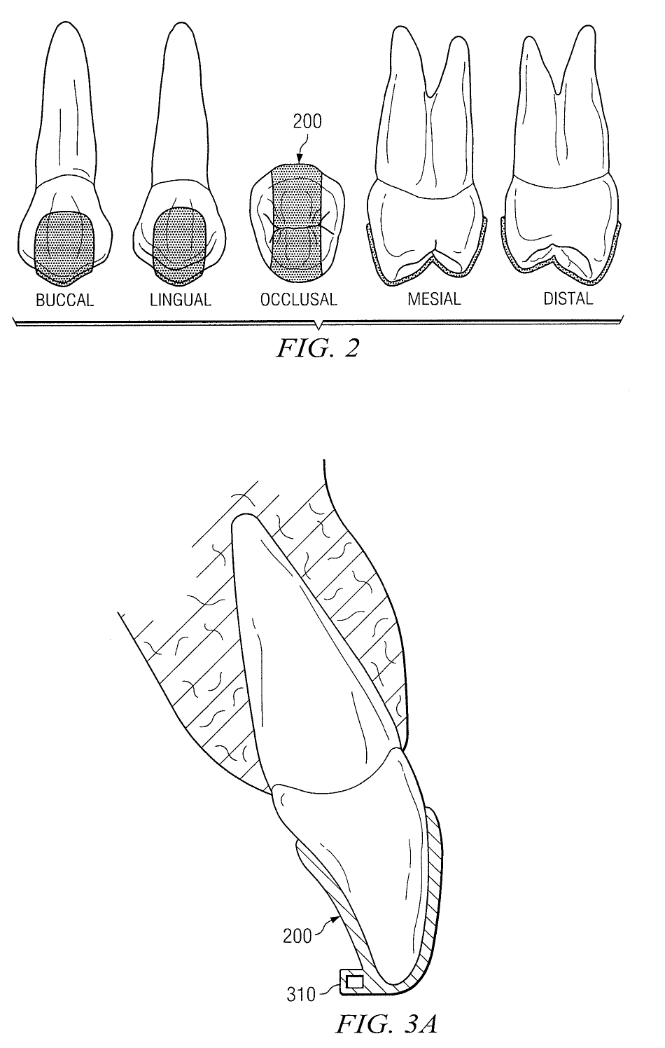

FIGS. 3A, 3B, and 3C illustrate side views of a cap 200 positioned on a maxillary central incisor according to various embodiments. Wire receptors 310 and 320 of FIG. 3A and FIG. 3B, respectively, each have a rectangular slots or openings through which orthodontic wire 104 may be threaded. The illustrated embodiments of FIGS. 3A and 3B differ, however, in that wire receptor 310 of FIG. 3A is positioned proximate the lingual surface of the tooth and wire receptor 320 of FIG. 3B is positioned proximate the occlusal (or incisal) surface of the tooth. In alternative embodiments, multiple wire receptors may be positioned proximate various surfaces of the tooth, as illustrated in FIG. 3C.

In the illustrated embodiment of FIG. 3C, three wire receptors 320, 330, and 340 are each coupled to cap 200 and are each configured to receive a respective orthodontic wire 104; however, any suitable number of wire receptors may be coupled to cap 200 (e.g., two wire receptors, three wire receptors, four wire receptors, etc.). In this example, wire receptors 320, 330, and 340 of FIG. 3C are positioned, respectively, proximate the occlusal (or incisal) surface of the tooth, the lingual surface of the tooth, and the labial surface of the tooth.

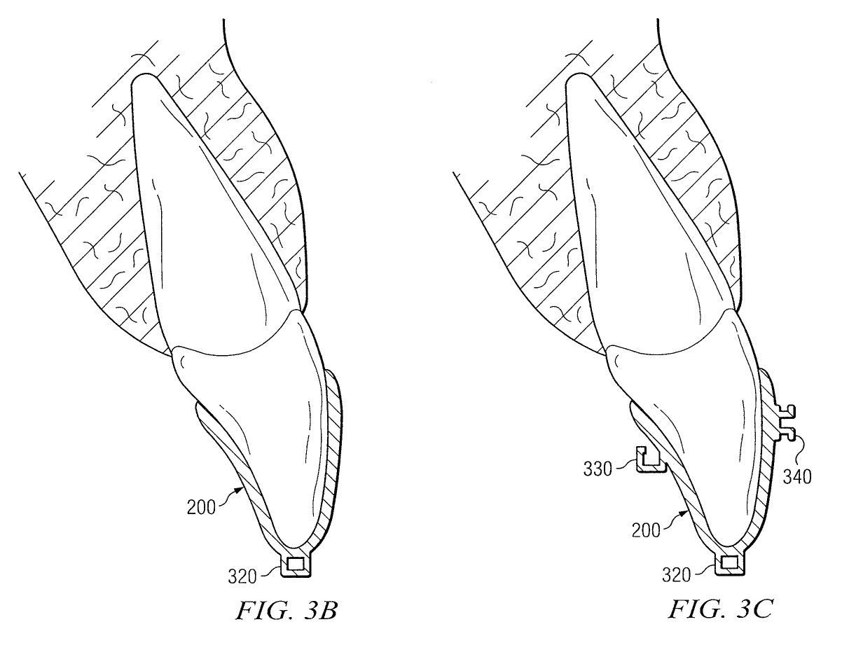

Although wire receptors 310-340 are illustrated as having particular configurations capable of receiving and coupling to orthodontic wire 104, each wire receptor 310-340 may have any of a variety of alternative shapes and/or configurations for receiving orthodontic wire 104. For example, one or more wire receptors 310-340 may have circular-shaped or oval-shaped slots through which wire 104 may be threaded. As another example, some wire receptors 310-340 may have partially enclosed slots or openings configured to receive orthodontic wire 104, as shown by wire receptors 330 and 340 of FIG. 3C. Additionally, some or all of wire receptors 310-340 may be self-ligating brackets. In certain embodiments, appliance 100 may utilize multiple orthodontic wires 104. For example, in certain embodiments, two or three orthodontic wires 104 may couple to or engage separate portions of a particular cap 200 or separate wire receptors associated with a particular cap 200. Some appliances 100 that use multiple wires 104 may facilitate the application of particular moments of force to teeth. For example, the illustrated embodiments of FIGS. 3C and 4A-4B may each apply any number of moments to a tooth including, for example, labio-lingual torque, a vertical force moment, and optimized rotational control.

In certain embodiments, removable orthodontic appliance 100 may include multiple orthodontic wires 104 of differing lengths. For example, appliance 100 may be configured such that, when applied to a user's teeth, a lingual orthodontic wire 104 may span the length of most of the user's arch and a labial wire 104 may span the length of a fewer number of teeth, such as, for example, the user's incisors.

FIG. 4A illustrates a side view of a cap 200, mounted to a maxillary central incisor, with integrated wire receptors 410, 420, and 430 according to one embodiment. FIG. 4B illustrates a lingual-perspective view of the cap 200 of FIG. 4A. In a particular embodiment, integrated wire receptors 410, 420, and 430 may each be integrally formed from the same material during the formation of arch 106 prior to the separation of caps 200. In this example, integrated wire receptors 410, 420, and 430 are formed so as to be positioned, respectively, proximate the occlusal (or incisal) surface of the tooth, the lingual surface of the tooth, and the labial surface of the tooth.

Integrated wire receptors 410, 420, and 430 may have any suitable dimensions to receive orthodontic wire 104. According to one embodiment, for example, the rectangular slots of integrally formed integrated wire receptors 410 and 420 are approximately 16×30 mills and 28×16 mills, respectively; however any suitable dimensions for the slots may be issued including, for example, slots having dimensions within the range of approximately 5 to 50 mills. In certain embodiments, integrated wire receptors 410, 420, and/or 430 may adjustably engage orthodontic wire 104 such that the wire 104 may be capable of moving or sliding relative to the integrated wire receptors 410, 420, and/or 430. In alternative embodiments, integrated wire receptors 410, 420, and/or 430 may be coupled to orthodontic wire 104 such that the wire 104 may be locked into position relative to arch 106, cap 200, and/or integrated wire receptors 410, 420, and/or 430. For example, one or more sections of orthodontic wire 104 may be wholly or partially embedded within arch 106, cap 200, and/or integrated wire receptors 410, 420, and/or 430. As another example, orthodontic wire 104 may be bonded, crimped, or otherwise fixed to arch 106 and/or the caps 200 formed from arch 106.

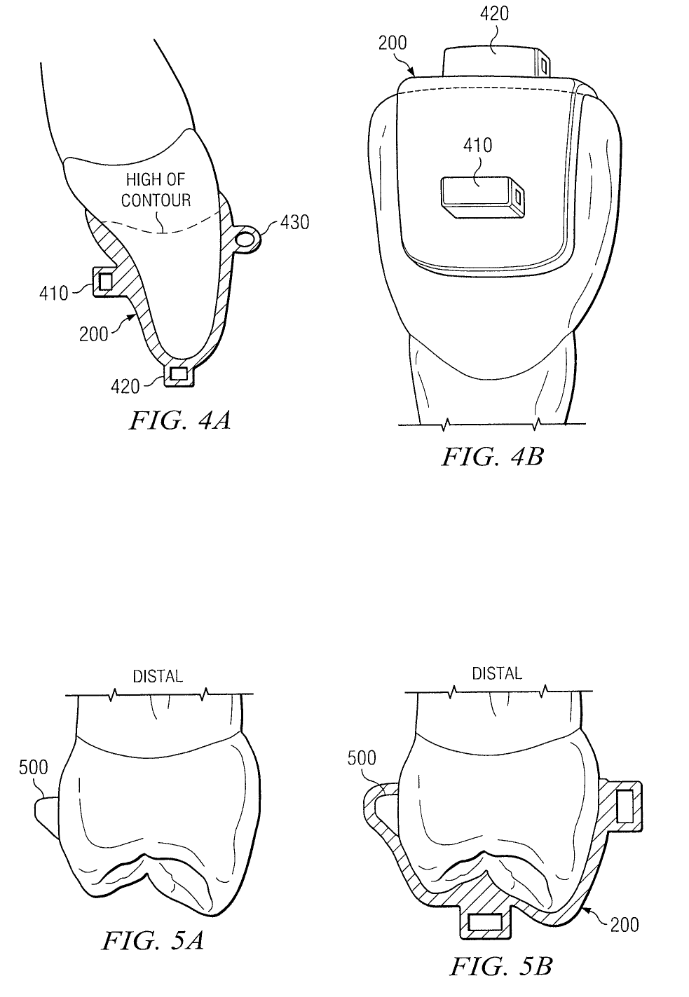

In some embodiments, the contour of cap 200 and/or the stiffness of cap 200 may provide a retentive force that facilitates coupling cap 200 to a tooth. In particular embodiments, one or more retention or anchor elements may be bonded to one or more teeth to increase the retention of cap 200, as illustrated with reference to FIGS. 5A and 5B.

FIGS. 5A and 5B illustrate an anchor element 500 according to one embodiment. In this example, anchor element 500 may provide improved coupling of arch 106 or cap 200 to the tooth. As illustrated in FIGS. 4A and 4B, for example, anchor element 500 may be bonded to a surface of the tooth and configured to engage a portion of cap 200, thereby improving the coupling of cap 200 to the tooth. In various embodiments, anchor element 500 may be bonded to a lingual, labial, or buccal surface of a tooth. In some embodiments, cap 200 may include a hole or indentation configured to engage anchor element 500 when cap 200 is applied.

In some embodiments, anchor element 500 may have a shape that facilitates installment of the cap. For example, anchor element 500 may have a trapezoidal (or keystone) shape to guide cap 200. Alternatively, anchor element 500 may have a cylindrical shape, a partial spherical shape, or any of a variety of other shapes that facilitate coupling or installment of the cap. In particular embodiments, anchor element 500 may be the only element of appliance 100 that is bonded to the tooth.

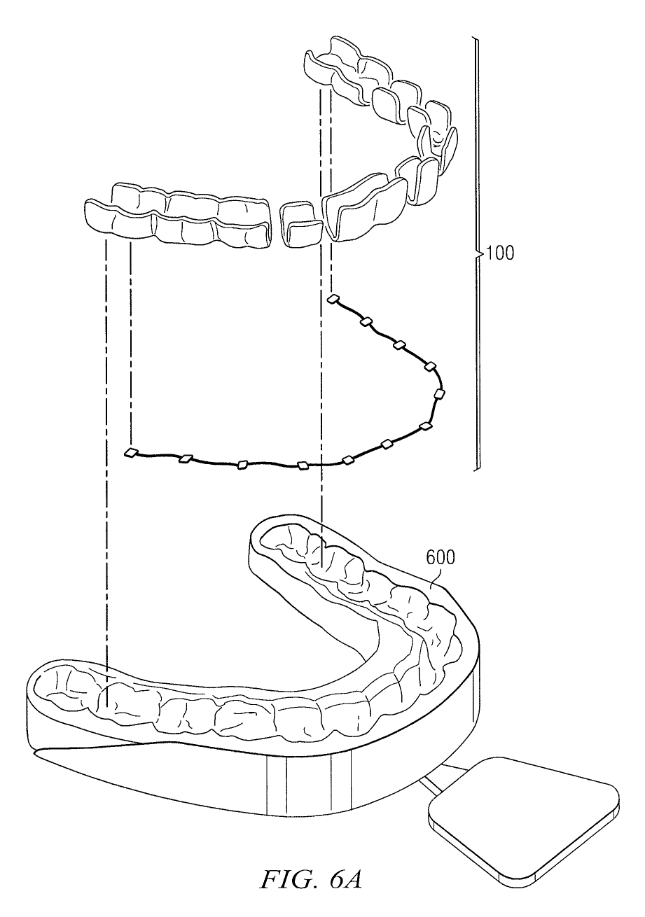

FIGS. 6A through 6C illustrate exploded views of removable orthodontic appliances 100 seated within a delivery tray 600 according to various embodiments. As shown in FIGS. 6A-6C, various systems of wire receptors 102 and orthodontic wire 104 may be used to couple together caps 200 to each other. In FIGS. 6A and 6B, a single orthodontic wire 104 may be used that spans most of the dental arch and couples all of the caps 200 to each other. As shown in FIG. 6C, multiple orthodontic wires 104 may be used in some instances to couple together particular caps 200 to each other. A myriad of variations may be used to provide improved flexibility in orthodontic treatment options.

In certain embodiments, delivery tray 600 is configured to receive appliance 100 and facilitate the positioning of appliance 100 onto the teeth of a user. In this manner, the user may remove and apply appliance 100 as desired to facilitate day-to-day activities, such as, for example, oral hygiene procedures, eating, etc. Various embodiments may provide improved flexibility in orthodontic treatment options. For example, appliance 100 may facilitate the movement or rotation of caps 200 relative to the wire.

In certain embodiments, delivery tray 600 may have a generic shape configured to fit the mouths of a variety of users. In alternative embodiments, however, delivery tray 600 may be an individualized tray configured to custom fit the mouth of a particular user. For example, delivery tray 600 may be formed of a thermoplastic material and custom molded to fit the particular user's teeth. In a particular embodiment, delivery tray 600 may be a “boil and bite style” mouth guard.

In this embodiment, the user may place the mouth guard in hot water, thereby softening the mouth guard material. The user may then use their fingers, lips, tongue, and/or biting pressure to seat the guard over appliance 100 and the user's teeth, thereby forming a custom fit. When the mouth guard cools the shape and orientation of appliance 100 is substantially fixed.

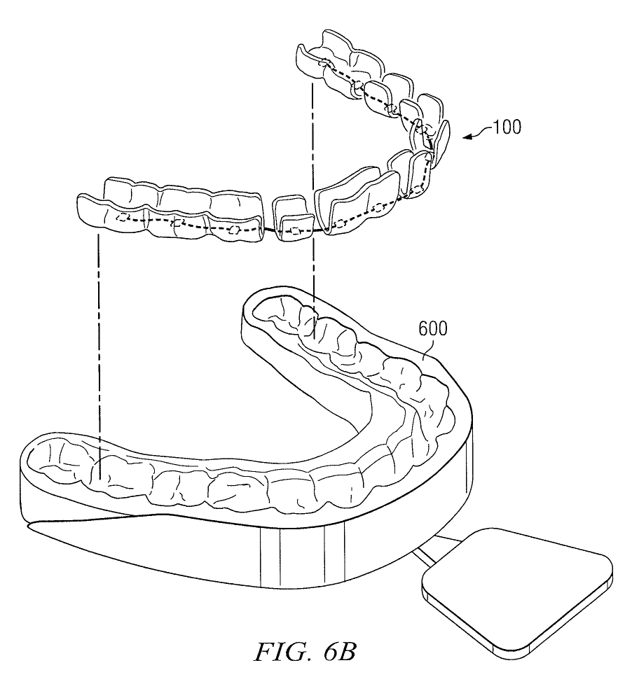

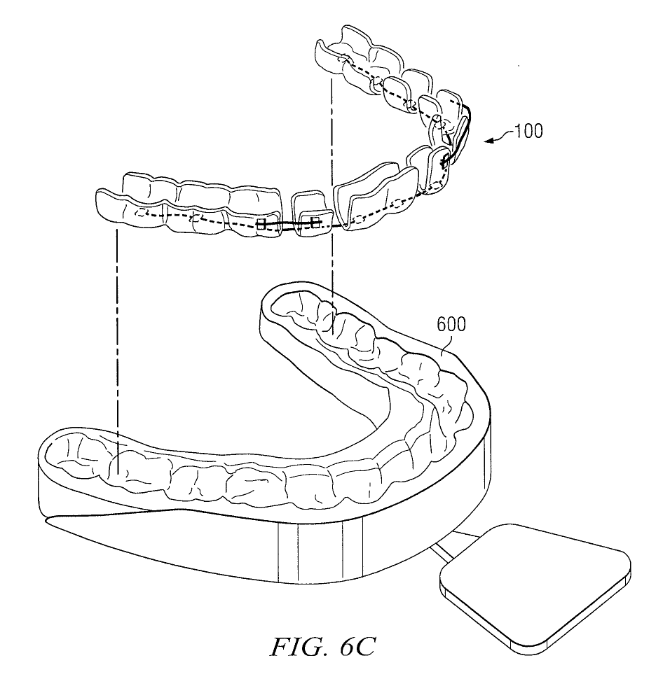

FIG. 7 illustrates an occlusal perspective of a variety of moments that may be applied to a tooth by appliance 100 according to certain embodiments. One advantage of the appliance 100 is that mesio-distal direction (tip) or labio-lingual direction (torque) can be applied to the crown of the tooth in a single moment. Because the line of the force passes far away from the center of resistance, a moment may be produced in multiple directions. Rotation may thus occur in any direction using wire receptors 102 placed proximate the most coronal part. Example rotation induced by forces being applied in the coronal part is illustrated metaphorically further in FIG. 8, which shows a screw moved by a screwdriver.

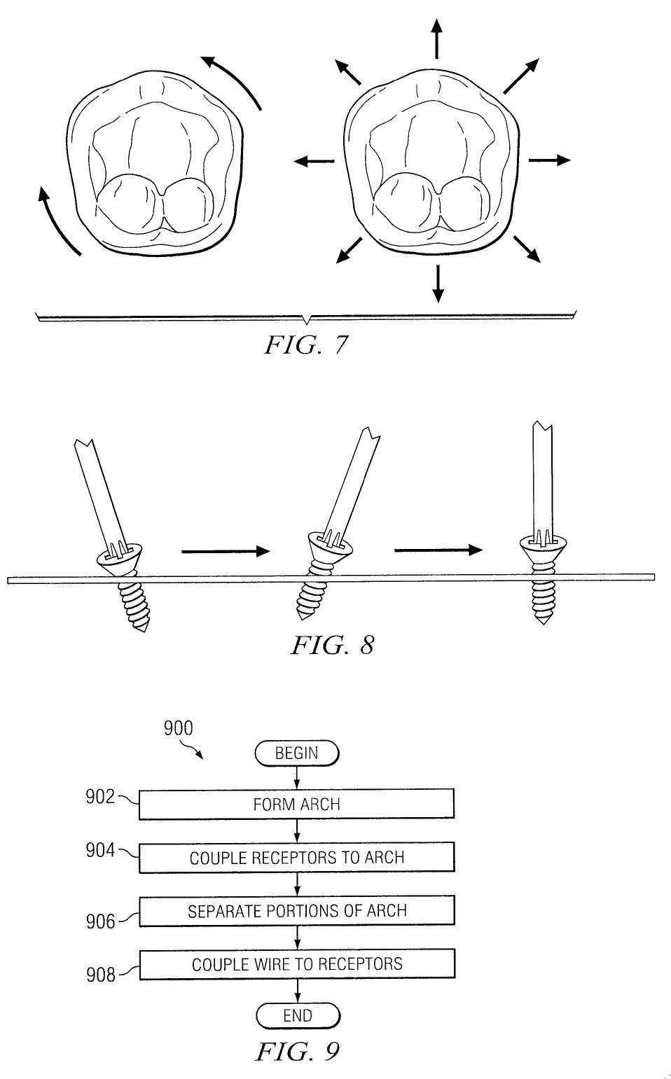

FIG. 9 is a flowchart 900 illustrating an example method of forming an orthodontic appliance according to one embodiment. In step 902, an arch 106 is formed. In certain embodiments, arch 106 may be formed from a mold of teeth or directly from the teeth, thereby providing a custom fit. Any suitable material may be used to form arch 106 including, for example, plastics, acrylics and/or composites.

In step 904, one or more wire receptors may be coupled to arch 106. In alternative embodiments, wire receptors may be integrally formed from the same material during the formation of arch 106, as discussed previously with reference to FIGS. 4A and 4B.

In step 906, arch 106 may be separated into sections. In certain embodiments the separation of arch 106 into one or more sections may be substantially similar to the separation of arch 106 into caps 200, as described previously with reference to FIG. 1D.

In step 908, one or more orthodontic wires 104 may be coupled to arch 106. In particular embodiments, one or more wires 104 may be coupled to arch 106 after arch 106 is separated into sections. Additionally or alternatively, one or more wires 104 may be coupled to arch 106 in step 908 after arch 106 is separated into one or more sections.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method of forming an orthodontic appliance, the method comprising:
forming an arch configured to custom fit a plurality of teeth;
coupling a plurality of wire receptors to at least two of:
a first surface of the arch corresponding to the lingual surfaces of the plurality of teeth;
a second surface of the arch corresponding to the labial surfaces of the plurality of teeth; and
a third surface of the arch corresponding to the occusal surfaces of the plurality of teeth;
separating selected portions of the composite arch;
coupling together a first pair of the plurality of wire receptors using a first orthodontic wire; and
coupling together a second pair of the plurality of wire receptors using a second orthodontic wire.

2. The method of claim 1, wherein each wire receptor of the first pair of the plurality of wire receptors is coupled to the third surface of the arch corresponding to the occusal surfaces of the plurality of teeth.

3. The method of claim 1, wherein the first wire is longer than the second wire.

4. The method of claim 1, wherein the first wire is more than twice as long as the second wire.

5. The method of claim 1, wherein the arch is formed from a composite material.

6. The method of claim 1, wherein the arch is formed from acrylic.

7. An orthodontic appliance comprising:
a plurality of orthodontic arch wires;
a plurality of caps, each cap configured to custom-fit the occlusal surface of at least one respective tooth;
a plurality of wire receptors each coupled to a respective one of the plurality of caps; and
wherein each wire receptor is configured to couple to at least one of the plurality of orthodontic arch wires.

8. The orthodontic appliance of claim 7, wherein at least one of the plurality of wire receptors is disposed outwardly from a position corresponding to the occlusal surface of the at least one tooth.

9. The orthodontic appliance of claim 7, further comprising a delivery tray configured to receive and position the plurality of caps.

10. The orthodontic appliance of claim 9, wherein the delivery tray is a thermoplastic mouth guard.

11. The orthodontic appliance of claim 7, wherein at least one cap of the plurality of caps is configured to engage an anchor element bonded to the at least one respective tooth, the anchor element configured to removably couple the at least one cap to the tooth.

12. The orthodontic appliance of claim 11, wherein the anchor element is bonded to a lingual surface of the tooth.

13. The orthodontic appliance of claim 11, wherein the anchor element comprises one of a trapezoidal shape, a cylindrical shape, and at least a portion of a spherical shape.

14. The orthodontic appliance of claim 7, wherein the cap is formed from acrylic.

15. The orthodontic appliance of claim 7, wherein the cap is formed from composite.

16. A method of forming an orthodontic appliance, the method comprising:
forming an arch configured to custom fit a plurality of teeth, the forming of the arch integrally forming a plurality of integrated wire receptors;
separating selected portions of the composite arch; and
coupling at least two of the plurality of integrated wire receptors together using a first orthodontic wire.

17. The method of claim 16, wherein at least one of the at least two of the plurality of integrated wire receptors is disposed outwardly from a position corresponding to the occlusal surface of one of the plurality of teeth.

18. The method of claim 16, wherein at least one of the at least two of the plurality of integrated wire receptors is disposed outwardly from a position corresponding to the labial surface of one of the plurality of teeth.

19. The method of claim 16, wherein at least one of the at least two of the plurality of integrated wire receptors is disposed outwardly from a position corresponding to the lingual surface of one of the plurality of teeth.

20. The method of claim 16, wherein the arch and the plurality of integrated wire receptors are formed from a composite material.

21. The method of claim 16, wherein the arch and the plurality of integrated wire receptors are formed from acrylic.

22. The method of claim 16, further comprising coupling at least another two of the plurality of integrated wire receptors together using a second orthodontic wire.

23. The method of claim 22, wherein:
the first orthodontic wire is disposed outwardly from a first surface of the arch;
the second orthodontic wire is disposed outwardly from a second surface of the arch; and
the first surface of the arch is substantially perpendicular to the second surface of the arch.

24. The method of claim 22, wherein:
the first orthodontic wire is disposed outwardly from a first surface of the arch;
the second orthodontic wire is disposed outwardly from a second surface of the arch; and
the first surface of the arch is substantially parallel to the second surface of the arch.

25. An orthodontic appliance comprising:
one or more orthodontic arch wires;
a plurality of caps, each cap configured to custom-fit the occlusal surface of at least one respective tooth, and each cap comprising one or more wire receptors, each wire receptor configured to couple to at least one of the one or more wires.

26. The orthodontic appliance of claim 26, wherein the one or more wire receptors are each integrally formed in respective ones of the plurality of caps.

27. The orthodontic appliance of claim 26, wherein at least one of the one or more wire receptors is disposed outwardly from a position corresponding to the occlusal surface of the at least one tooth.

28. The orthodontic appliance of claim 26, further comprising a delivery tray configured to receive and position the plurality of caps.

29. The orthodontic appliance of claim 28, wherein the delivery tray is a “boil and bite” mouth guard.

30. The orthodontic appliance of claim 26, wherein at least one cap of the plurality of caps is configured to engage an anchor element bonded to the at least one respective tooth, the anchor element configured to removably couple the at least one cap to the tooth.

31. The orthodontic appliance of claim 30, wherein the anchor element is bonded to a lingual surface of the tooth.

32. The orthodontic appliance of claim 30, wherein the anchor element comprises one of a trapezoidal shape, a cylindrical shape, and at least a portion of a spherical shape.

33. The orthodontic appliance of claim 26, wherein the cap is formed from acrylic.

34. The orthodontic appliance of claim 26, wherein the cap is formed from composite.

35. A method of forming an orthodontic appliance, the method comprising:
forming an arch configured to custom fit a plurality of teeth;
coupling at least two wire receptors to the arch;
separating selected portions of the composite arch; and
coupling the at least two wire receptors to each other using an orthodontic wire.

36. The method of claim 35, wherein at least one of the at least two wire receptors is disposed outwardly from a position corresponding to the occlusal surface of one of the plurality of teeth.

37. The method of claim 35, wherein the arch is formed from a composite material.

38. The method of claim 35, wherein the arch is formed from acrylic.

39. An orthodontic appliance comprising:
an orthodontic arch wire;
a plurality of caps, each cap configured to custom-fit the occlusal surface of at least one respective tooth;
a plurality of wire receptors each coupled to respective ones of the plurality of caps; and
wherein each wire receptor is configured to couple to the wire.

40. The orthodontic appliance of claim 39, wherein at least one of the plurality of wire receptors is disposed outwardly from a position corresponding to the occlusal surface of the at least one tooth.

41. The orthodontic appliance of claim 39, further comprising a delivery tray configured to receive and position the plurality of caps.

42. The orthodontic appliance of claim 41, wherein the delivery tray is a “boil and bite” mouth guard.

43. The orthodontic appliance of claim 39, wherein at least one cap of the plurality of caps is configured to engage an anchor element bonded to the at least one respective tooth, the anchor element configured to removably couple the at least one cap to the tooth.

44. The orthodontic appliance of claim 43, wherein the anchor element is bonded to a lingual surface of the tooth.

45. The orthodontic appliance of claim 43, wherein the anchor element comprises one of a trapezoidal shape, a cylindrical shape, and at least a portion of a spherical shape.

46. The orthodontic appliance of claim 39, wherein the cap is formed from acrylic.

47. The orthodontic appliance of claim 39, wherein the cap is formed from composite.

47. An orthodontic appliance comprising:
an arch configured to mount on a user's teeth, the arch comprising one or more structures each configured to removably couple to one or more respective anchor elements bonded to the user's teeth.
